(19) United States
(12) Patent Application Publication
(10) Pub. No.: US 2017/0076264 A1
(43) Pub. Date: Mar. 16, 2017

(54) AUTOMATED PLATFORM AND PROCESS FOR OBTAINING, RECORDING, ANALYZING, SENDING AND RECEIVING INFORMATION BETWEEN USERS AND PRODUCTS

(71) Applicant: INTERACCIÓN MÓVIL SA de CV, Col. Condesa (MX)

(72) Inventors: Gustavo Martin Ross Quaas, Col. Pedregal (MX); Manuel Rodrigo Rábade Garcia, Col. Navarte Oriente (MX)

(73) Assignee: INTERACCIÓN MÓVIL SA de CV, Col. Condesa (MX)

(21) Appl. No.: 14/855,230

(22) Filed: Sep. 15, 2015

(30) Foreign Application Priority Data
Sep. 10, 2015 (MX) MX/A/2015/012192

(51) Int. Cl. G06Q 20/18; G06Q 40/00; G06Q 20/20

(52) U.S. Cl. CPC G06Q 20/18; G06Q 20/202; G06Q 40/12

(57) ABSTRACT

The invention herein is related to platforms, methods and operational processes of the management of automatic vending machines, which then generate reports, give statistics of functionality, reports failures, allows transactions with or without cash or a combination of both, if this invention is associated to a telemetry device.

### BACKGROUND OF THE INVENTION

The present invention is related to an automated communication platform between users (individuals) and a third party, who could be the manufacturers of consumer products, in such a way that information can travel in both directions while being recorded, stored, classified, linked and organized and thus able to generate reports and carry out multivariable personalized analysis associated with the following fields: product, brand, presentation, frequency of consumption, preferences, portion size, date of consumption, product condition, price, temperature, geographic location, change in location, timeliness of delivery, food freshness, packaging characteristics, organoleptic perception (odor, taste, texture) of the user/consumer, side effects of the product after a period of consumption/use, the product's interaction with other products, the guarantee, batch control, control of personalized post-sale behavior and personalized product delivery according to preset conditions, among many other variables which can also be combined among each other.

The platform consists of: the users; user profiles on social networks; products and their identifying characteristics, from descriptive and physical characteristics to codes or identification systems; a mobile device associated with a user identified by a multi-frequency code; a communication network of mobile devices made up of cellular phones, tablets or similar devices; an Internet communication network; interrelated databases of the users, products, machines and their characteristics; a network of automatic vending machines and an integrated telematic device on the vending machines.

### STATE OF THE ART

There are currently automatic vending machines that commonly include devices that operate electronically and mechanically that permit a certain degree of autonomy in delivering diverse products, such as snacks, drinks, tickets, electronic equipment, etc. These machines operate such that a product is given as the result of a series of steps, which begin with the selection of the product through a payment for the product's price, in which the payment is in cash or made by a credit card or a prepaid card.

As is known in the field, there exist usage protocols for automatic vending machines, such as the MDB protocols emitted by NAMA (National Automatic Merchandising Association), which is a voluntary standard which regulates the “master/slave” settings between the machine controller (VMC) and the peripherals of the automatic vending machine, for example the coin and bill acceptors, credit card readers, etc., and the other protocol DEX emitted by the EVA (European Vending Association) which is similarly based on a voluntary standard that defines the type of communication between the vending machine controller (VMC) and another device, such that the former transmits to the latter sales information, for example, as well as various activities associated with the operation of the machines, and their control and status.

The patent MX278696, for example, protects the method that perfects automated sales, principally focusing on identifying and monitoring the behavior of the machine and the sales associated with each of them. The patent differs from the present invention in that it does not consider the user and the user's information.

Other machines can also be considered in their operation, such as point of sale bank terminals, in which a salesperson connects to a remote bank operator, such that the user's transactions are authorized by the bank service provider. Given that bank data are entered into the point of sale terminals or handled via an intermediary operator, these transactions are carried out with a high level of risk, since the security is in the hands of third parties.

More recent machines have the option of carrying out transactions via the cellular network. The disadvantage in these cases is that the communication often becomes interrupted and may stop the transaction during the purchase of a product. Other factors can cause users to lose a solicited transaction, such as the lack of cell phone service or loss of the telephone network's signal in the middle of a transaction.

Going deeper into the current state of the art, the U.S. Pat. No. 6,584,309B1 deals refers to a method for buying products from an automated vending machine via a cellular telephone network, in which to get an available product from the machine one needs to dial a telephone number of the service provider. The server recognizes the product request, generates a sales code which is sent to the consumer's cell phone via the cellular phone network, where upon receiving the code the consumer enters it to the vending machine, where the code may be in the form of an RF, a tone or a manual code. The machine processes the code and resends it to the operator to validate the sales code, and once validated the operator instructs the vending machine to release the product.

One difference between the above mentioned invention and the proposed invention here is that the proposed platform does not need to connect with the cell phone service provider, since this generally requires alliances and contracts that establish communication protocols, along with cost schemes between the businesses. In one of the invention's forms the communication can be directly from the machine to the Internet; thus, a user via their mobile device can interact with the invention through a cell phone network that includes SMS and Internet, a local network provided by the vending machine such as Wi-Fi, or personal networks such as Bluetooth and RFID. Another difference is that the bank operator does not receive the sales code again for its validation; the validation is carried out in the telemetry device in the invention described here.

The patent application EP1205890 A1 refers to an Internet payment device for automated vending machines which consists of: a communication interface with at least one automated vending machine; computational means capable of supporting the Internet transmission of data identifying the automated vending machine; a connection for the transmission and reception of such data to and from a remote Internet operator; the means of communicating the vending machine's identification data to a buyer. In this system, when a consumer with a cellular device capable of connecting to the Internet requires a remote bank operator for a payment, the communication device connects to the Internet in order to navigate on the remote Internet platform of the bank operator via the operator's web server, which is preferably seen as Internet web pages on the communication display. One of the differences between this technology with the proposed invention is that the machine with the proposed invention has an Internet connection and does not require Internet access from the user's mobile device. This allows that the access, recording, control and storage of information be controlled by the associated platform and does not depend on a user having Internet access or not.

Another way in which the proposed invention is different is that the user's interaction with the vending machine is carried out independently of the Internet connection of the vending machine; that is, the user interacts from their own Internet connection whether it be a cell phone or any other device; optionally, the machine can provide Internet access to other users via its own connection which can be cellular or any other type.

The patent application US 20140179231 A1 deals mainly with the use of a device to provide telemetry services to monitor the sales and operations of an automatic vending machine, and also refers to the display of advertisements in exchange for some other activity. This is highly dependent on the interface hardware of the vending machines with the user. The patent application also mentions a system in which the user can access the Internet only via the vending machine's interface. While the aforementioned Internet access mainly involves the appearance of an advertisement, in another embodiment of the patent the user can have free Internet access for a predetermined time period, sending the user the identification and location of the machine through the cellular network by the advertising system, and once the user receives the passwords via cellular network from the advertising system, authorization is provided for the user to use the LAN wireless network for a short period of time, after which the user must pay for more connection time.

The proposed invention described and claimed here permits the user, among other things, to interact via an Internet connection from their mobile device, avoiding depending on the status of the machine's Internet connection. It allows the user to pay for the products via a prepaid account, and also allows funds to be added and funds to be shared, among others that will be apparent from the description of the invention.

In terms of technologies associated with the control of the machines, there exists the patent MX307004 which reveals an electronic device for sales in ticketing machines, for products and services that are not physically inside the machines, that is, intangibles. This uses an integrated circuit that incorporates into the controller board of an automatic vending machine. Such a circuit does not contain a data processing system with diverse information registries associated with the vending machines or with the users, and it also doesn't incorporate fuzzy comparators, both which are elements of the current invention. The patent MX307004 also is unable to switch between various communication protocols, as is possible with the proposed invention.

As seen in the current state of the art, the user must go through several complex steps that require the use of their own resources, such as phone calls to acquire products from an automatic vending machine, in which the user makes a telephone call to receive a special validation code, which is entered by the user into the automatic vending machine, so that the machine validates this code via a second authorization code sent by the machine operator. This puts the user at a high risk for the loss of money or the loss of the requested product or service. Furthermore, the current state of the art has a low compatibility with machines that do not have a receipt printing device for credit card purchases.

Another problem with the current state of the art is that for each intermediary in the operation of the automatic vending machines, the processes for operating the sale and release of the product are more complex and dependent on the operations for each intermediary. Each machine also requires a range of technological equipment for the operation of this complex structure, which requires specialized maintenance, in which during periods of malfunction can be long and costly.

Another problem with the current state of the art is that for a user to pay for the desired product, they must provide their bank data and personal identification to an operator that is not their own financial provider, in order to validate and pay for the product. This makes users very wary of using such systems.

Another still unsolved problem in the current state of the art is that automatic vending machines only allow the completion of the payment for a good or service via transactions from bank accounts, cellular credit accounts or cash.

Therefore, vending machines need a method and a system that allows users to interact with the vending machine from a mobile communication device (i.e. cell phone, tablet, etc.) and via the vending machine's own keyboard, so that the vending machine gives the desired product or service in an easy and efficient manner, without complex procedures and without the need to give bank information or personal information to a third-party operator that handles and validates the user's banking data, which exposes the user to fraud.

There also exists the need for the implementation of a system in vending machines that allows payment transactions not only via cash, bank credit or credit from a cellular operator, but that also allows payments via prepaid accounts and a combination of the above.

There also exists the need to upgrade the first generation vending machines at a low cost, giving them the ability to add credit to a prepaid account.

Given the inventory of existing vending machines already installed throughout the world, it is necessary to transform the operations of these machines in a simple and efficient manner, solving their current problems without having to dispose of them outright. A plan is required in order to integrate the existing machines so they can operate on the platform presented by the present invention.

As seen in the review of the technology of the current state of the art, none of the current technologies deal with the following novel elements of the present invention:

An interactive, information-processing platform that specifically includes the detailed and personalized information of the user/consumer, including the possibility of linking user information to the user's social network profiles.

An interactive, information-processing platform that includes the ability to obtain user information based on one interaction with the machine. This can be done at different times from the moment of the vending machine's release of the product or service, since the platform is designed to store the details of the user interaction and classify the user with the products or services the user receives, so that the platform can recall this information simultaneously or at another moment, and link additional data given by the user with respect to the product, and send this data to the platform for its analysis and storage. This information is classified and stored in the linked database registries in the platform and can be delivered to product manufacturers according to the specific criteria of each case.

A platform that identifies and interacts with the user, regardless of the machine being used, since the data management and interaction is carried out from the platform and not in the machines. This allows for the recording of patterns of user activity and movements between different machines in the network, categorizing information about the times, dates and user consumption in different machines, even though these belong to different operators, as long as these are connected to network of machines on the platform.

A platform that also offers payment options in cash and prepaid cards, among other options, through the machines on the network, for example using physical cards with a code, payment with an electronic debit or credit card, or cash at the vending machines and even in convenience stores. Also, that the user has the option of sending credit to other users, such that the balance associated with the account can be used to purchase products and services at the machines on the network, due to the platform's information database which links the consumer with the product, linked through the interaction with the machines on the network.

The platform is able to store user profile information (including the link to their personal social networks), associated with a multi-frequency code of a mobile device, and can also register a change in the multi-frequency code that updates with the user's registered profile in the platform, using an algorithm that updates the user profile.

Given that the platform has specific databases associated with the user and user characteristics, these characteristics can be linked with a prepaid account and linked to the machines on the platform's network. The machines can be identified on the network with an alphanumeric code, a numeric code or a combination of the two, through which the user can interact with the machine and search its content. Also, the name of the machine is linked with the serial number of an electronic telemetry card and an associated operation key, which allows the card to link to the machine as a security mechanism to guarantee that they physically connect and that communication is made between the control of the vending machine and the internal and external peripherals.

The platform can also establish specific conditions for the release of determined products, independent of whether these products should be purchased; that is, the platform can send information to the network of machines so that these may release a product to the user/consumer, even when the consumer did not pay with any type of payment system (cash, credit card, o credit via a cell phone services). With a different method, users can exchange or send products in such a way that the product will be sent to a user receiving a product or service at an automatic vending machine, that receives a delivery code.

The operation of a machine independent of a payment or purchase is possible due to criteria comparators and fuzzy comparators, which allow the determination of the release of products and services based on user profile information and the interaction with the vending machine, since the conditions established by the platform administrator are associated with specific user characteristics, for example age, gender, consumer preferences, preferences for certain products, along with other conditions associated with consumer behavior or characteristics the user needs to satisfy (for example, the consumption of a product over a certain period of time, downloading a certain application, or publishing a post on a social network). The conditions described above can be recorded and saved in the platform and linked to the user database, the database of products and specific conditions to release a product, independently of the machine with which the user interacts, and saving data associated with their characteristics.

The platform can also maintain a record of the information between the user, the product and the conditions under which a specific product was released, so the information may be compared and different routines can be carried out according to the results, which may vary over time, for a specific user and with regards to a specific product.

For the reasons mentioned above, the present invention solves the interaction problems between automatic vending machines, and also allows for the machine to obtain user information, manage it, record it and use it in a later moment, associated and linked to different products and services. Additionally, this platform is made up of machines that are already operational the moment that the telematic device (which is part of invention) is installed, which allows the connection of the information regarding the operation of the vending machines and the information from the platform regarding the management of Internet data. As a result, the platform allows the release of determined products independent of any payment process and also accepts payments via prepaid accounts as a single form of payment or combined with other forms of payments, which allows users to acquire products or services offered by the network of machines connected to the platform.

### BRIEF DESCRIPTION OF THE FIGURES

FIG. 1 shows a perspective view of an automatic vending machine.

FIG. 2 shows a representation of the interaction between the automatic vending machine, the operator and the data processing system.

FIG. 2A shows a diagram of the interaction between the user, the data processing system and the vending machine.

FIG. 3, shows related entities by the data processing system

FIG. 4 shows a functional block diagram of the interaction between the user application and a management system (DXC).

FIGS. 5, 6 and 7, show functional block diagrams of the interaction of the telematic device, the management system (DXC) and an operator interface.

FIG. 8 shows the functional block diagram of the electronic device of the telematic interface in its interaction with the data processing system and the automatic vending machine.

### DETAILED DESCRIPTION OF THE INVENTION

The present invention refers to platforms, automated processes and management systems implemented by computer for the transactions on automatic vending machines and the interaction with a platform of electronic transaction management systems via the use of wireless communication technologies, for the control of vending machines and furthermore its management, administration, recording, classification, storage and analysis of user data from the vending machines.

To explain how this invention functions, numbers will be used to reference or point out elements in the various diagrams. The terms used in the singular, for example, are not limited to their singular use and may be understood in their most ample use. As an embodiment example for this invention, a multi-frequency identification code may be used, however for a technician with knowledge in this field of work, it is evident that various means of identifications associated with smart electronic devices may be applied to identify the user, as is for the invention's implementation.

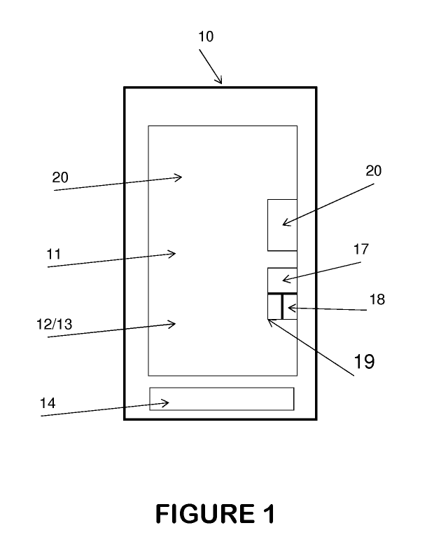

Now referencing FIG. 1, which gives a perspective view of the automatic vending machine (10) and points to some elements that comprise an automatic vending machine: automatic vending machines generally have a storage area (20) that contain products, with, for example, worm gears, springs, or some other mechanical system (11) that expels the product (12) towards the take-out port (14); a user panel (15) which allows for the interaction of the user (30) with the automatic vending machine (10) to select a product (12) or service (13); tags or signs for identifying the products inside the automatic vending machine (not shown); payment areas, such as a coin slot (17), bill slot (18), and credit card readers (19). In addition to the aforementioned elements, the machine may also have temperature sensors, product sensors, illumination and refrigeration systems, systems for monitoring operations and inventory, warning system product failure, etc., technology operation such as a control computer (not shown), a telematic device as part of the invention contained inside the machine (10) which operates via MDB/DEX between the vending machine control (VMC) and an embedded computer, connected to the Internet by various means such as a cellular network, a wired or wireless network, or a satellite network, etc.

The telematic device (800) permits the release of the products or services, connected to the computer which is connected to the Internet to exchange information with the management system (DXC) and identify the products and services to release, while on the other end the telematic device is connected to the vending machine control (VMC) which executes the operational instructions for the automatic vending machine.

Automatic vending machines (10) can have one or several means of interaction with the user (30) and the operator (35) of the vending machine, for example, a wireless Internet transmitter, a LCD display screen, at least one keyboard, a touch-screen, voice recognition, payment systems such as a credit card reader, coin and bill slots, transceivers that allow the network device to establish communication with other devices and systems, for example the communication interface can include wired or wireless communication transceivers (Ethernet, Wi-Fi, LAN, GPRS, Bluetooth, ZigBee, SigFox, etc.).

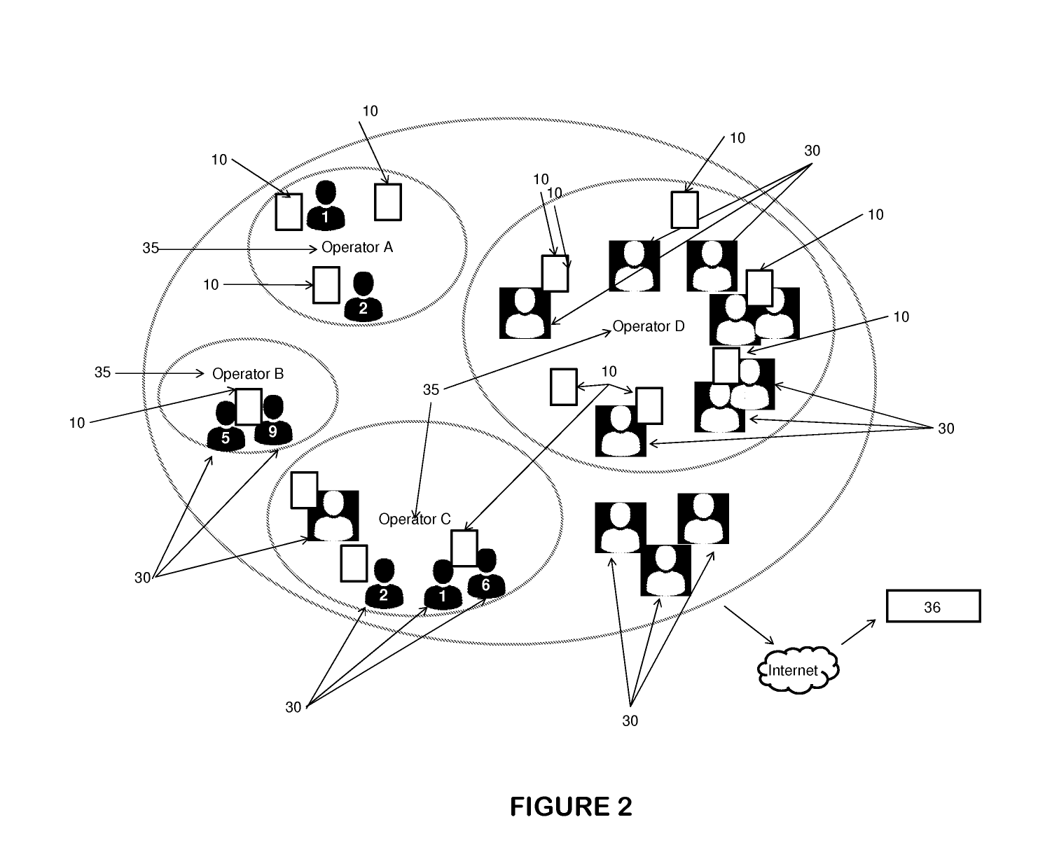

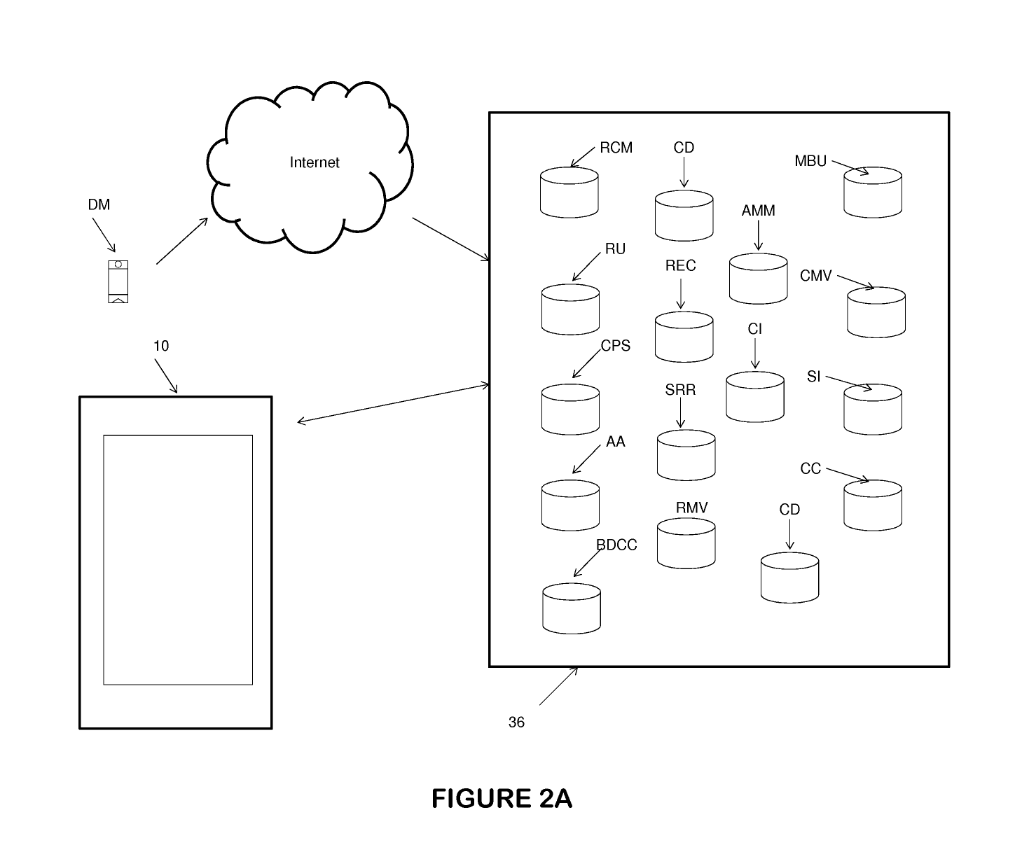

As shown in FIG. 2, a network of automatic vending machines can be scattered throughout economically active sectors or they can be together in a geographically set area, forming a network of automatic vending machines. In FIG. 2 we can see an ensemble of automatic vending machines, which may be interconnected between themselves and operated by unique operators (A, B, C, D, etc.), being connected to the operator via a wireless or wired Internet connection, such that the vending machines of operator A cannot be manipulated by operator B, and so forth.

The operator can obtain operational reports from at least one of their automatic vending machines, reports on products sold, the amount of money in the vending machine, giving the operator the ability to manage the restocking of sold-out product. These reports are generated through the use of NAMA and DEX/UCS protocols, which are part of the current state of the art.

In FIG. 2, the ensemble of automatic vending machines operated by operators A, B, C, D, etc. are linked by a data processing system (36) which generates and administers the user profile information in the automatic vending machines and also the information regarding the products and services the user receives. Upon establishing direct communication with a user's mobile device, the system (36) also records, stores, analyzes and administers the information in the same way.

The data processing system gives a signal to the automatic vending machines on the network, using unique identifiers which may be alphanumeric, numeric, or a combination of both, for example a combination of a symbol such as the “at” sign (@) and numerical code, in order to determine the location of each of the automatic vending machines. The data processing system can obtain reports from all of the automatic vending machines on the network, for example reports related to the behavior of a user, products purchased, the release of product samples, the products with the greatest and least demand, the impact of advertising campaigns, all associated with analysis and the quantification of data that previously could not be done.

The data processing system has a multifunctional matrix analysis function for large quantities of data (AMM), which can be sent to the operator or operators (35) of the automatic vending machines on the network. This is a tool that helps operators (35) make better decisions regarding the products in their automatic vending machines, such as the possibility of evaluating the implementation of a customized campaign of a sample of products, in which variables such as product, size, presentation, price and frequency of purchase are included in the data storage and compared and analyzed with the previous information regarding the products and of the consumer who received the product.

The data processing system (36) contains one or more processors; at least one hard disk memory; relational databases that contain for example new and active users; a catalog of the automatic vending machines; the IDs of the automatic vending machines, the prepaid accounts, their balances and deposits into the account; databases of dynamic information; it may also include at least a search engine that allows the administration and management of information within the database, according to the variables and criteria entered by a user via their user profile. The at least search engine can also contain a criteria comparator, a fuzzy comparator (CD), and an information sorter (CI) that all interact with the relational databases, which compare the established selected criteria with the user criteria, giving a result of the characteristics that match the pre-established selected criteria.

This system can have a connection with a user's intelligent mobile device through any type of internet connection, in such a way that the solicited products or services from the automatic vending machine can be compared with the criteria of the release of a product.

The data processing system (36) identifies the user or users (30) that have interacted at least once with an automatic vending machine (10) of an operator (35) of automatic vending machines, showing the products paid for and the products that have been given under specific conditions established by the system (36), allowing the system to measure, analyze and graph the frequencies of interaction between the users at the automatic vending machines. The data processing system (36) can also perform recommendations to the operators (35) of automatic vending machines in order to improve the decision-making that can result in increased interaction between a user (30) and the automatic vending machine, related to variables of the user profile and other variables such as time, quantity, frequency, location, and product, among other variables.

The data processing system (36) can contact all the users (30) of the automatic vending machines on the network who satisfy certain pre-selected criteria, for example age, gender and profession, etc., which allows to link certain products offered by the vending machine with users that satisfy the pre-selected criteria, increasing user traffic for certain or all of the automatic vending machines in the network.

In another embodiment, an operator of an automatic vending machine on the network may contact only those users who have had at least one interaction in their automatic vending machines, and who satisfy certain pre-selected criteria, such as age, gender and profession, etc., to generate user traffic and purchases of the products offered by the automatic vending machines and thus increase profits, selecting the users by means of the pre-established criteria that interacts with the fuzzy comparator and the information sorter. Even further, the system is capable of identifying a user after an interaction with a different vending machine from the one the user initially used; that is, the system has a module that records, stores and is capable of identifying user information, in such a way that it also stores the information associated with a user's specific consumption profile and the geolocalization of the machine that generated the original information, saving the desired parameters within the system memory.

FIG. 2A shows a functional diagram which relates the data processing system (36) with operators of automatic vending machines (35), with the automatic vending machines (10), with users/consumers (30), and with the products and services of the automatic vending machine. The data processing system (36) identifies and obtains the physical location of the automatic vending machines on the network from one or all the operators, obtains and analyzes the user-generated data such as suggestions and reports; can generate conditions to offer products and their prices based on analysis based such as the flow of users (30), usage habits (time of day, quantity and frequency) and other analysis of user habits, the product managing conditions and the retail prices established by the operator or operators of the automatic vending machines; can identify the multi-frequency of the mobile devices of the user (DM), their name, age, sex, purchase history, social network, preferences, type of device used, device brand, location, opinions, sample results, elasticity (product demand and turnover), the time period of a product in the automatic vending machines, opinions and evaluations of a specific product, from which the data processing system (36) can generate statistics, purchase reports, customer quantity, etc., which will help the operator make decisions with regards to the products offered by their automatic vending machines and increase their profits.

FIG. 2A shows a part of the database that makes up the data processing system (36) in which said system (36) can store a record of multi-frequency codes (RMC), a record of users and user profiles (RU), an ID catalog of the automatic vending machines, user search engine (MBU), prepaid accounts and their balances (CPS), the database of conditioned criteria (BDCC), the authentication administrator (AA), the dynamic and permanent information server (SI), the record of conditional sales (REC), the recharge server (SRR), and vending machine reports (RMV). It can also have multifunctional matrix analysis (AMM), an information sorter (CI), a criteria comparator (CC) and a fuzzy comparator (CD).

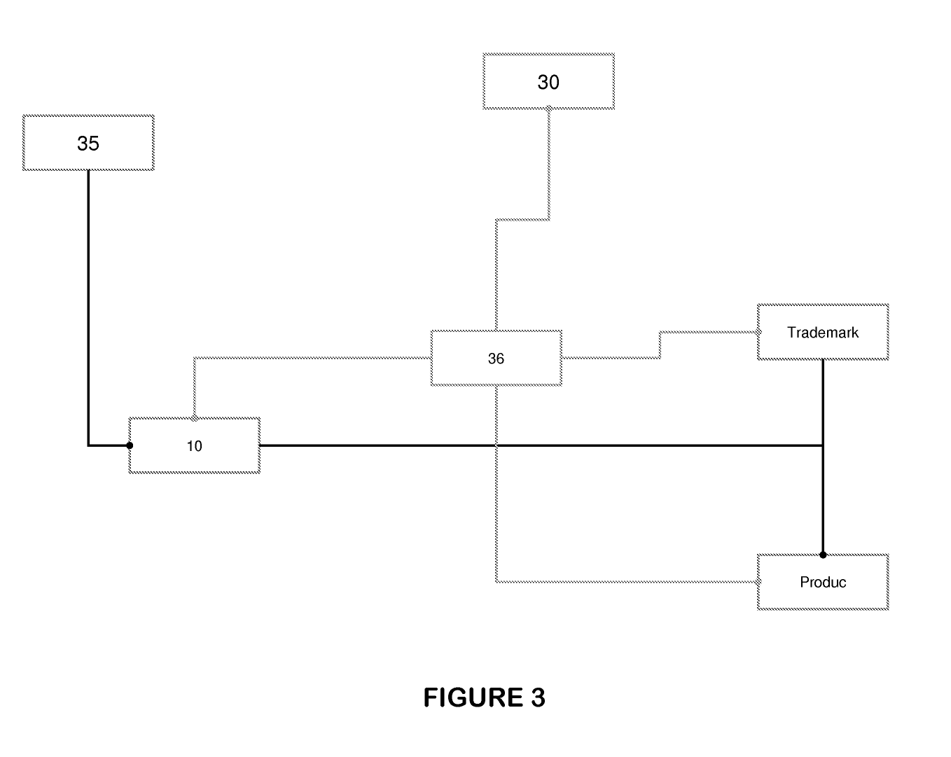

FIG. 3 shows the chart of the entities connected via the data processing system, in which the system analyzes, graphs, determines and generates information based on the interactions carried out by the vending machines.

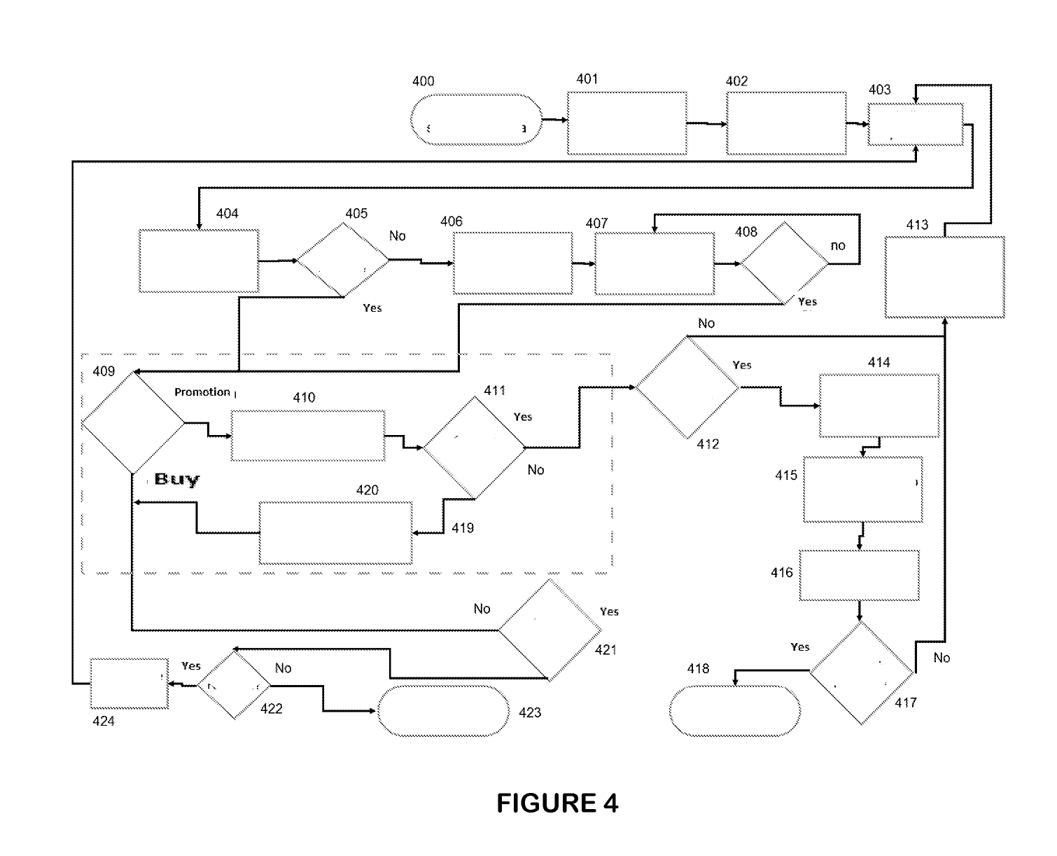

FIG. 4 shows a functional block diagram of the process of a product request at an automatic vending machine on the network, via a portable smart device with Internet access (not shown), for example, a smartphone, tablet, or PDA, etc. According to the invention's method, the diagram illustrates the basic steps to initiate the interaction with a vending machine (10) on the network of automatic vending machines operated by an operator.

In the first step the user begins the interaction via an application on a cell phone, web page, or another place (not shown), which allows communication to be established with the data processing system (36), identifying (401) one of the automatic vending machines on the network (such as the machine (10) shown in FIG. 1) upon giving the data processing system the ID machine, name of the machine, or the data contained in a QR code of via the geolocalization of the machine (the identification data can be found on the body of the automatic vending machine).

The user can navigate through the list of products (402) available in the vending machine (10) via their smart device, selecting and requesting a product (403) via their portable device (the smartphone), and at this moment the user is identified (404).

If the user had not previously initiated a session (405) they may register themselves as a new user or use their previous record by giving the multifrequency ID of the smart mobile device (406) and entering a verification code into the device that they will receive via SMS message (407). In case their text message system is not available, the invention's data processing system (36) will generate a phone call to give the verification code to the user.

The verification code should be entered into the invention's data processing system by the user via a smart electronic device (i.e. cell phone, PDA, personal computer, or tablet, etc.) which can interact with the data processing system, be it through a cell phone application, web page or any other interface with the data processing system. If the verification code does not match (409) with the code sent via SMS, a new verification code is sent (407) or the smart mobile device's multi-frequency identification will be allowed to be corrected (406).

If the code entered by the user in their smart mobile device matches (409) with the code sent via SMS, the data processing system determines if a previous user profile exists associated with the multi-frequency identification of the smart mobile device. In the case that a profile exists, the previously registered data, preferences, payment methods, etc. are used. In case a user profile does not exist, a new record is created in the user database.

Once the user's smart device multi-frequency code (409) has been verified, if it is related to a conditioned delivery, the fuzzy comparator (CD) of the data processing system (36) verifies the criteria (BDCC) (CC) previously established for such conditions (410), and proceeds with the product release process if the criteria are fulfilled (411). In case that the criteria of the conditioned release are not fulfilled, the system registers the information and offers the user to procure the product by other means, or to procure another product.

If the requested product (403) is related to a purchase (409), the data processing system (36), based on the information within the associated database, identifies the prepaid accounts (CPS) associated with the multi-frequency code of the smart device, analyzes and determines (421) the balance of the account by comparing it with the cost of the product to be purchased.

If during this phase (421) it is determined that the credit is insufficient to continue with the purchase process according to the associated data base, the data processing system sends the user a message offering the user (423) to add funds to their prepaid account via the vending machine (the process of adding funds is described further on). If the user does not accept the aforementioned option, the data processing system may offer the user to either pay the product by other means—for example, by means of a debit, credit card, etc.—or to complete the payment associated to the product—for example, by means of a credit or debit card, etc. If no option is chosen, the data processing system completes the operation and logs out.

Likewise, the user has the possibility to add funds to their prepaid account by means of physical cards with a code, payment with debit card/electronic credit, as well as in self-service/convenience stores; moreover, the user may also receive a credit from another user's account.

As for FIG. 4, once a download is authorized when the established criteria has been fulfilled (411), or by a direct purchase (422), the data analysis system establishes the availability in the vending machine (10) of the requested product based on the data collected from the vending machine (10) and stored in the vending machine status log (RMV). If the product is available to be released, its procurement shall be authorized (414). The user must confirm the release of the product by means of entering a verification code on the vending machine interface (415) given to the user by means of their mobile smart device. If the product is not delivered (417) due to a vending machine failure, a warning is generated by the vending machine, which is reported to the operator and the data processing system (36), being stored in the vending machine status log (RMV), and sending the user (413) a message requesting them to change their product selection, and initiating the process again in the steps described above (403).

However, if the product is released, the sale is registered (418) in the databases linked to the user (RU) receiving it into the log of conditioned product released (REC). Furthermore, the product in the vending machine status log is removed (RMV).

If the user chooses to add funds to their prepaid account with money in the vending machine, the data processing system completes the operation so as to allow a deposit via the vending machine (which will be described further on). Having completed the process, the system runs the purchase phases previously described in FIG. 4, starting off from phase 403 in FIG. 4.

The prepaid accounts can be all those accounts that allow to receive credit installments, accepting credit cards, debit, and accounts associated to charges for mobile or local phone, among others.

In an embodiment of the invention, the data processing system (36), allows the user to procure a product using their prepaid account balance, and to complement the cost with either cash or credit card.

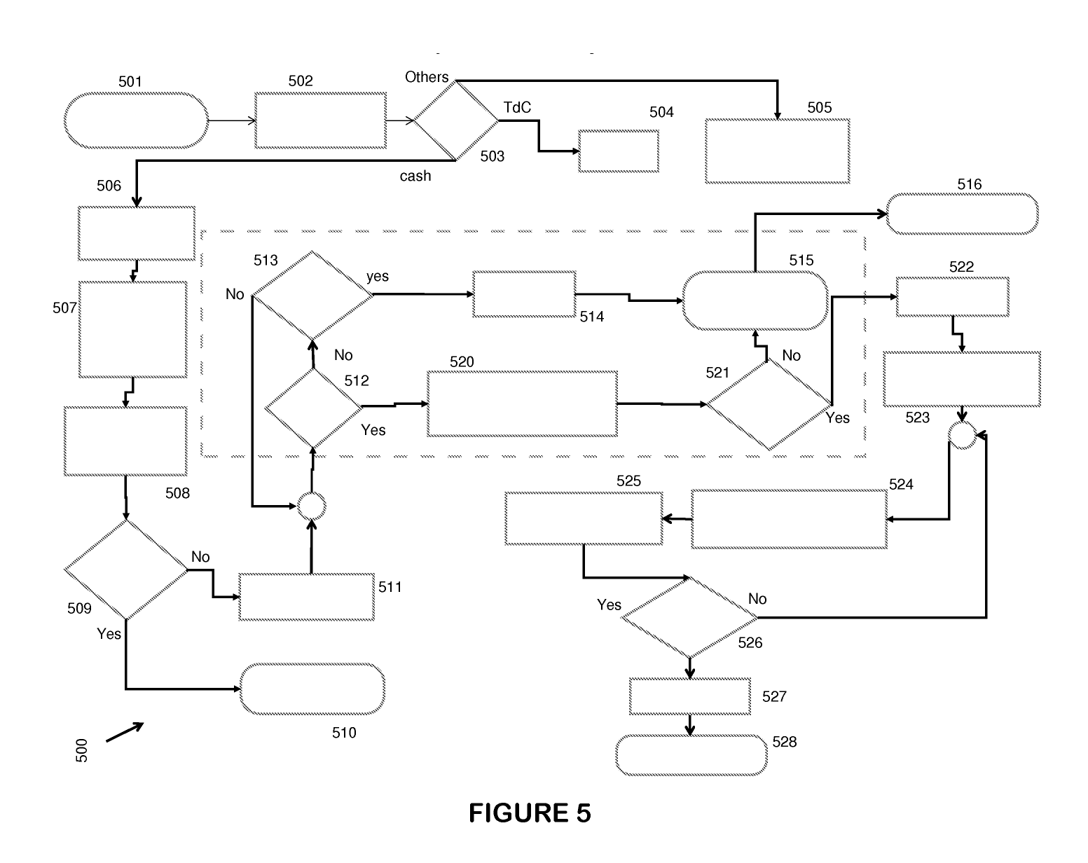

As for FIG. 5, a functional block diagram of the process of adding funds (500) to a prepaid account (CPS) is shown. The funds deposit process is carried out entirely with the vending machine. The funds deposit in phase (422) FIG. 4 is carried out as following:

In step 501, the funds deposit process to a prepaid account begins. The data processing system via the increase system (SRR) pays out the associated balance into the prepaid account linked to the multi-frequency code within the prepaid accounts database (CPS) of the data processing system (36) once it has authenticated the user's data (502); having authenticated the data, the data processing system sends the user a message (503) requesting him to indicate the method in which they will add funds, which may be cash, physical cards with a code, payment with debit cards/electronic credit, with cash in an automatic sales machine, and even in self-service/convenience stores. The deposit process done with credit/debit cards may be executed by the user's smart device.

With a cash deposit the user is able to make a selection (506) on the vending machine regarding how the funds will be added to a prepaid account, identifying it with the name of the machine, QR code or some other identification method available in the selected machine (10). The data processing system, by means of the increase section, indicates (507) a digital crossed connection method embedded in the data processing system (36) to generate a deposit code according to the machine planogram (10). The user will be given the code by the data processing system (36) via the user's mobile smart device. Likewise, the digital crossed connection means, sends the vending machine's telematic device (800) a pairing request (508). The telematic device verifies if there are any stored transactions (509); if that is the case, the digital crossed connection method in the vending machine will not be available (510), informing the data processing system about it, canceling the request, and sending the user a message requesting them to try later.

If during the aforementioned step (509) the telematics system does not detect stored transactions, a transaction session (511) with the vending machine control (VMC) is opened verifying whether the user has confirmed (512) the transaction code in the vending machine that has been previously selected. If the user does not confirm the code in a certain period of time, the session concludes with the VMC and the user is automatically informed via their mobile smart device of a failure, and the data processing system (36) is informed that the funds deposit process was not completed, thus finalizing the process (516).

If during the aforementioned step (512) the user confirms the payment code to the prepaid account, the digital crossed connection means is given the code entered, and logs out (520) on the VMC. The digital crossed connection means informs (521) whether the code entered is correct. If the entered code is incorrect, the user (515) is automatically informed by means of their smart mobile device of a failure, informing the data processing system (36) too that the increase process was not completed, thus concluding the process (516).

If during step 521 it is determined that the code entered by the user is correct, a session is logged in (522) with the vending machine control (VMC) so as to ask the user (523) in their mobile smart device to deposit the cash into the vending machine (10). The VMC accepts the cash introduced into the vending machine, and informs the digital crossed connection method about the cash being received; the digital crossed connection means may thus inform the user via their mobile smart device or via a machine interface about the amount of cash received (525). If the user has indicated the data processing system with their mobile smart device that the money inflow is done or if the continuity in the reception of the cash by a period of certain time is interrupted (30 sec, 1 min, etc.), the system pays the amount received in the automatic sales machine into the prepayment account, and logs out of the VMC.

If in step 526 the cash inflow continues, phases (524, 525, 526) keep on executing until the data processing system, via the user's mobile device, is informed that the cash input is finished, or until the cash inflow is interrupted so as to inform the data processing system the received amount to be paid into the prepaid account; then logging out with the VMC in step 527.

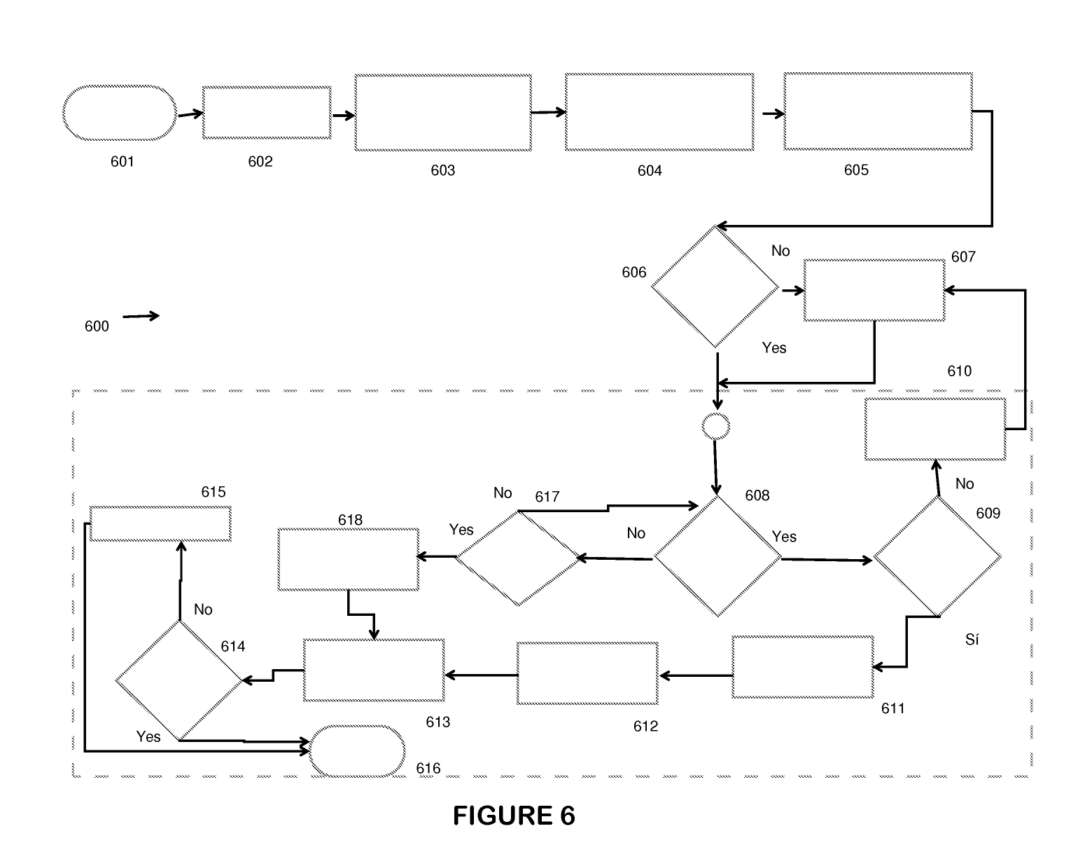

In FIG. 6 a functional block diagram of the product delivery authorization process is shown, and where a modality of the operation of an automatic vending machine on the network is exemplified (10).

Step 601 is related to the authorization for the product delivery in the machine (10) after the process described in FIG. 4, where in step (602) the data processing system makes a transaction in the digital crossed connection means, which sends (603) the telematics interface device (800) an instruction of a new transaction, storing (604) in the telematics device (800) the MDB code of the authorized product, transaction number, and expiration time. In phase (605), the digital crossed connection means is informed that the transaction is being processed. If the session is not logged (606) in the VMC, the telematics device (607) logs in with the VMC so as to continue with the confirmation of the product code in the automatic sales machine, as shown in FIG. 4. If the product in the machine (10) in the step (608) has been confirmed, and the authorized MDB code has been typed (609) in the machine (10), the VMC verifies in the telemetry device the received code in order to determine during phase (611) the product delivery, then activating the mechanical systems to take the product to the collection area, informing (612) the digital crossed connection means about the delivery outcome, and storing such log in the vending (RMV) machines reports; further on the information about the transaction made in the telemetry device is eliminated (613). If stored transactions to be executed do not exist in the telemetry device, the delivery process is concluded (616). If there are stored transactions in the telemetry device in step (614), it logs out (615) with the VMC after the execution of the stored transactions, or due to the dwell time of the non-executed transaction in the telematics device, and then concludes (616) the delivery operation.

As for step 608, if the user has entered a non-authorized MDB code (609), the telematics device denies the delivery so that the VMC logs out, and a new session with the VMC is logged in (607) so as to execute again the stages corresponding to the users' concurrency cycle corresponding to previously described phases 608 to 616.

If in step 608 the user does not confirm the product in the vending machine, step 617 determines the transaction expiration on a dwell time basis, informing (618) the digital crossed connection means that the dwell time has been exceeded, then eliminating the transaction (613), and either logs out with the VMC in step (615) and concludes (616) the delivery operation, or concludes directly (616) the operation after step (613) where the transaction information is deleted.

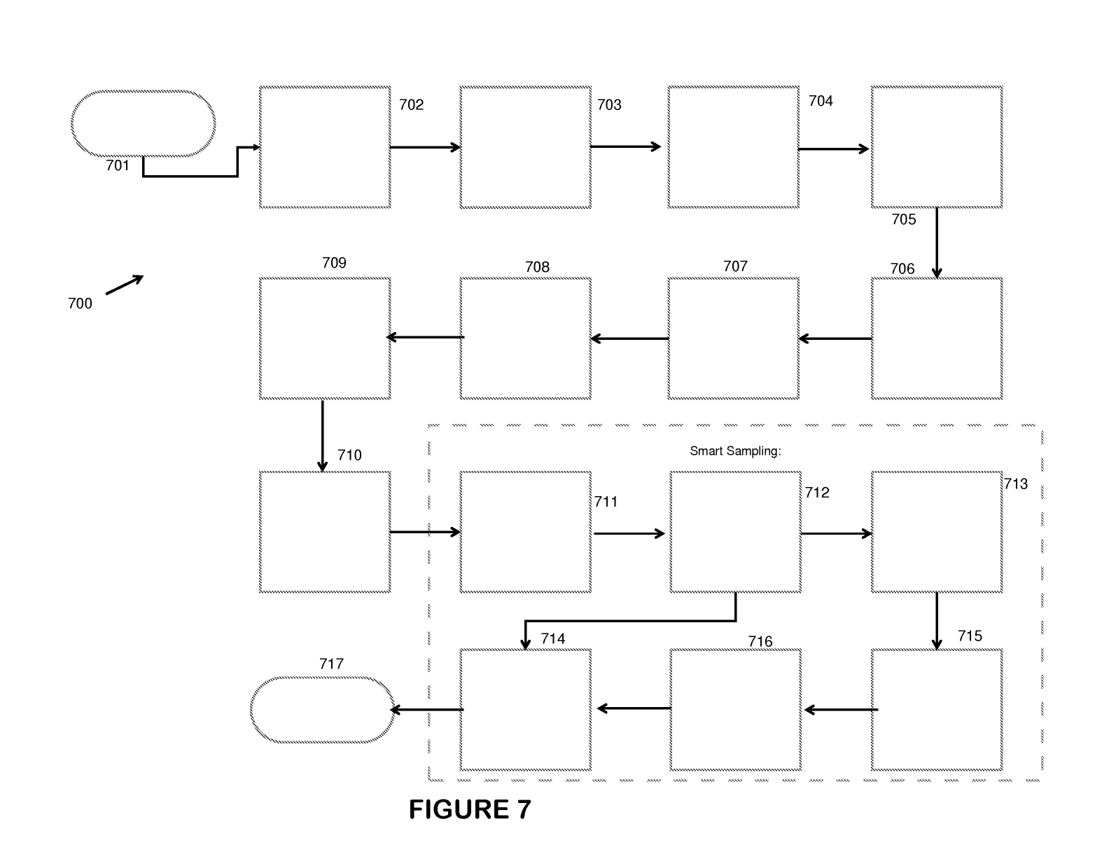

As for FIG. 7, a functional block diagram to generate a conditioned product release is shown, where the data processing system (36) transmits the information to each one of the vending machines within the network if such is agreed upon. The data processing system (36) contains a relational database that stores the resulting data of the conditioned product release executed (REC), analyzing these results so as to generate reports based on this analyzed information.

In step 701, a conditioned product release is created through the data processing system (36), defining a geographic area (702) where the generated conditioned product release will be effective, defining the participating automatic machines (703), the participating products, the profile that the user shall fulfill in order to participate in the conditioned product release, as well as applicable conditions/requirements to the conditioned product release (706), which is stored in the criteria comparator, and is executed by the fuzzy comparator. One of the conditions of the conditioned product release may be that a given user may receive a product per day in exchange, for instance, of a tweet, a Facebook publication or f some other activity that is registered in the system; even in exchange for filling out forms to collect and store data besides of establishing start-end dates (707) within this conditioned product release will operate.

The data processing system (36), based on the data and criteria of the conditioned product release, is able to consider and inform about the impact volumes (708) of the conditioned product release, and to program the launching and publishing of the conditioned product release. Once the conditioned product release has been published, the data processing system is able to contact (711) the users contained in the active (RU) or new users data bases, and that fulfill the established criteria for the delivery (712) of participating products in the conditioned product release. Step 713 allows to monitor the results in certain created periods of time in conditioned product delivery. Step 715 requests the participating users' feedback so as to successfully collect the answers (716), keeping the information, analyzing it, grouping it and generating reports of physical release in step 714, whereas further on, a final report with the analyzed results can be additionally generated (716); such results include the information collected by the system through forms the user fills out, then concluding the process in the set date for the conditioned product release aim.

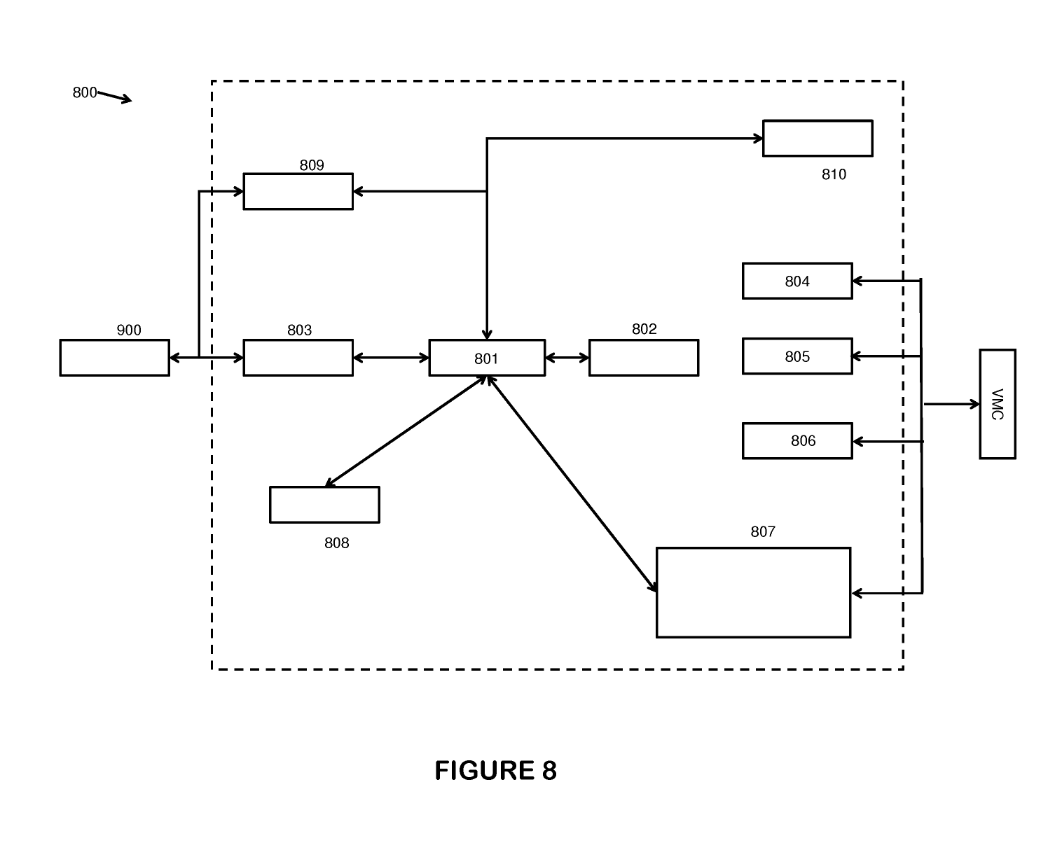

As for FIG. 8 now, in which a diagram of the telematics interface electronic device used in this invention is shown, for the interaction of the data processing system and the vending machine, it has the following:

In the telematics interface (800) through which the phases of product release and the depositing of funds into a prepaid account are developed, vending machine data as well as information exchange and instruction between the data processing system (36) and the vending machine (10) are obtained. Thanks to its groundbreaking architecture in a single card, it easily combines the different and necessary devices for vending machine information, communication and operation including: being expansible in order to control new vending machine interfaces (10), for instance, the sale of intangible products, the delivering of intangible products, accepting cash or any activity programmed in the computer, that such telematics device is connected to.

The device (800) has a microcontroller (801) or a microprocessor or any programmable device with the capacity to execute the recorded orders in its memory, and to interpret sales machine MDB and DEX protocols, and to switch between these protocols. The device (800) microcontroller (801) operates by means of a serial protocol (UART) to control the computer (900) that connects to Internet a reset button (808), a multiplexor (802) and vending machine operation interfaces (804 to 807), as well as light emitters. The device is also capable of controlling, for instance, displays, printers, purses, wallets, credit card readers, and other external peripherals.

The device (800) is able to contact with a vending machine by means of a RS232 interface serial port (805) for the DEX protocol; an opto-isolated serial port (804) for the MDB protocol; a multipurpose TTL serial port (806); at least five input ports for sensors. For example, for the shock sensors, temperature, opening of doors, product delivery interface, etc., or that can work like outputs for actuators. For example, LED indicators, LCD screens, motors, etc.

Moreover, it has at least six energy outputs for accessories; for example, for sensors and actuators, a reset button, at least three status bi-color LEDs, and a power plant accepting a up to 40V DC input.

The device (800) also combines the following interfaces so as to connect with the computer:

At least a TTL or USB serial communication port, as well as at least one power plant that can provide with 5V DC and up to 1 Ampere of power.

The device (800) works by means of a communication protocol between the device (800) and any computer. This protocol enables the access and interconnection of interface sources and elements that the device includes (800).

For the vending machine-computer information transmission by means of the MDB protocol, the device (800) works as an information regulator (buffer), receiving the information from the computer and storing it until getting a periodic request of information from the VMC (not shown) generally towards a hardware device (polling) to create a vending machine synchronous activity. For the reception of the vending machine-computer information by means of MDB protocol in the telematics device, the information the automatic sales machine receives is filtered through MDB direction, and it only sends the information that is related to the computer.

In the DEX mode, the telematics device is in charge of the automated processes of negotiation that establish on a dynamic basis the parameters of an established communication channel between two entities before the normal communication begins by the channel (handshake) necessary so that the computer itself sends or receives the DEX file in frames of communication protocol used in the microcontroller (801). At the end of DEX method, the device (801) switches automatically to MDB mode.

If in MDB mode there are no pending transmissions or receptions, the device sends frames if the operation button is pressed or the digital inputs change. It can also receive frames to act on the outputs and the LEDs.

Moreover, the microcontroller (801) allows updating its firmware by means of its serial port integrating thus new protocols or functionalities without modifying the hardware.

In a device mode (800), it can be connected to a computer without any Internet connection, or to any central computers as long as it has a web camera allowing the vending machine to deliver a product; for instance, if it takes a picture of a person even if it is not online.

The description of the invention presented herein is not of restrictive nature; it only exemplifies some of the modalities that the invention may have. A technician with average knowledge in the subject will understand that the user's interface may be any smart device, and that one shall not limit oneself to the example described herewith. The terms used shall not be interpreted like restrictive, but they shall be understood in their widest interpretation. Singular terms are applicable on a plural basis.

1. A method implemented by computer for operations in automatic vending machines associated to a remote data processing center that includes the following stages:
a) Identifying an automatic vending machine from a network of automatic vending machines by a wireless data method;
b) Asking for a product from the wide range of products contained in the vending machine;
c) Identifying the wireless data method in a relational database by the reception of a multi-frequency code;
d) Initiating an interaction session with the relational database;
e) Registering the multi-frequency code in the relational database;
f) Generating and sending the system to the wireless data method, a number code—alphanumeric or a combination of those;
g) Selecting a product in the vending machine;
h) Remotely establishing the availability of the product in the machine for the delivery of the requested product;
i) Authorizing the release of the product in the vending machine;
j) Registering the delivery in a relational database of a remote data processing center different to the relational database from phase C.

2. The method implemented by computer for operations in automatic vending machines associated to a remote data processing center of claim 1, where the requested product in stage b) can be a conditioned product release or a product for sale.

3. The method implemented by computer for operations in automatic sales machines associated to a remote data processing center of claim 1, where the following phases before phases h to j are executed so as to deliver the product from a conditioned product delivery:
k) Comparing data from the wireless data method to the parameters established in a relational database at the remote data processing center that contains the parameters of at least one conditioned product delivery;
l) Determining whether the data from the wireless data method fulfill the established parameters of for at least one conditioned product delivery.

4. The method implemented by computer for operations in automatic sales machines associated to a remote data processing center of claim 3, where the method offers a purchase in the wireless data method when the criteria of at least one conditioned product delivery are not fulfilled; linking the wireless data method to a prepayment account in a relational database at the remote data processing center, which is different to the data bases in stages j) and c) so as to determine the availability of balance in the prepayment account to cover the requested product cost. If the credit is suitable, the availability in the automatic sales machine is verified, charging it to the account, and phases i) and j) are executed.

5. The method implemented by computer for operations in automatic sales machines associated to a remote data processing center of claim 4, where if the credit is not suitable for the payment, an option is sent to the wireless data method to top up in the account associated to the multi-frequency code of a wireless data method.

6. The method implemented by computer for operations in automatic sales machines associated to a remote data processing center of claim 5, where the top up to a prepayment account phase executes the following phases:
i) Authenticating in the relational database of phase c) a multi-frequency code of the wireless data method;
ii) Establishing a method to add funds to a prepaid account;
iii) Generating a code in the data processing center according to availability of the automatic vending machine, sending the code to the telematics device for the delivery in the automatic vending machine;
iv) Sending a pairing request from the DXC to a vending machine telematics device;
v) Determining, by means of the telematics device, the existence of stored transactions in it so as to execute the delivery in the automatic vending machine;
vi) Logging in with the vending machine VMC if the automatic vending machine is available; or canceling the request when the vending machine is not available;
vii) Providing with the code received with the wireless data method in the automatic sales machine;
viii) Notifying the DXC about the code received in the automatic sales machine;
ix) Logging out with the VMC;
x) Logging in with the VMC if the entered code in the vending machine was correct;
xi) Entering cash in the automatic vending machine;
xii) Accepting the cash from the VMC, and informing the DXC about the cash reception;
xiii) Informing by means of the DXC, using a visualization interface in the vending machine the amount of received cash, and sending the amount received to the data processing center in order to be paid out into the associated prepayment account;
xiv) Logging out with the VMC;

7. A system to display user information, which includes:
One or more processors;
At least one hard-disk memory, which includes:
A user log that contains user's information;
A log of multi-frequency codes adapted to associated wireless communication methods with registered users;
A log of activities or routines of a user's interaction, which contains a log of the interactions that a user has made in at least one automatic sales machine;
A log of at least one automatic sales machine, adapted to identify on a global basis the location of the automatic sales machine;
An information server adapted to receive a wide range of information;
A criteria comparator adapted to associate the wide range of information;
A fuzzy comparator adapted to execute the user's interaction matches with the criteria associated to the wide range of information that the user will be displayed.

8. System according to claim 7, which in addition includes an adapted sorter to link the wide range of the information with the user's interactions.

9. System according to claim 7, where in addition the fuzzy comparator allows to relate the user's data, the user's interactions and the wide range of information, where the information the user is displayed is selected out of the wide range of information based on the results from the fuzzy comparator.

10. System according to claim 7, which in addition includes a log of prepaid accounts.

11. System according to claim 10, where the prepaid accounts log also allows to know each prepayment account balance.

12. System according to claim 7, which in addition includes a log of automatic vending machines reports

13. An adapted telemetry device so as to carry out the method according to claim 1, characterized because it contains a central programmable method; an activity reset button of the automatic sales machine; at least a multiplexor and operation interfaces of the vending machine; light emitters; at least an interface serial port for DEX protocol; at least a serial port for MDB protocol; at least a multipurpose TTL serial port; at least an input port for the sensors interface; at least an energy output for accessories such as sensors and actuators, status LEDs, power plant where the programmable method interprets and switches MDB and DEX protocols enabling the communication between the automatic vending machine control and a computer by means of at least one of the serials ports for DEX protocol, MDB protocol, and a multipurpose TTL serial port.

14. The telemetry device in claim 13, characterized in addition because the device microcontroller is able to operate by means of a serial protocol (UART) to control the computer and the access and interconnection of the interface methods, and elements that the device includes. Additionally, the controller has the ability to control displays, printers, purses, wallets, credit card readers, and other external and internal peripherals.

15. The telemetry device in claim 13 additionally characterized because the input port for the sensors interface can work as sensors interface of shock, temperature, opening of doors, product delivery, etc., or can work as an output for actuators; for instance, LEDs, LCD screens, motors.
